(19) United States
(12) Patent Application Publication
(10) Pub. No.: US 2015/0379595 A1
(43) Pub. Date: Dec. 31, 2015

(54) AUTOMATED REACTIVE RETAIL PRICING THROUGH MULTILEVEL HIERARCHICAL REGRESSION

(71) Applicant: Kiran Gange, Foster City, CA (US)

(72) Inventor: Kiran Gange, Foster City, CA (US)

(21) Appl. No.: 14/752,820

(22) Filed: Jun. 26, 2015

Related U.S. Application Data
(60) Provisional application No. 62/017,830, filed on Jun. 26, 2014.

(51) Int. Cl. G06Q 30/02

(52) U.S. Cl. CPC G06Q 30/0283

(57) ABSTRACT

A system and method for automated reactive retail pricing through multilevel hierarchical regression is disclosed. A reactive retail pricing server obtains a set of relevant data, creates a plurality of merchandising sets, and transforms the set of relevant data. Coefficients are calculated for a group model, and are then reverse transformed. Recommended pricing is calculated using the group model, where retailer strategies, retailer goals, and price campaign parameters are applied as constraints. The coefficients are automatically calibrated, and the price campaign is adjusted.

### CLAIM OF PRIORITY

This application is a non-provisional conversion application of and claims priority to the U.S. Provisional Application No. 62/017,830 titled, AUTOMATED REACTIVE RETAIL PRICING THROUGH MULTILEVEL HIERARCHICAL REGRESSION filed on Jun. 26, 2014.

### FIELD OF TECHNOLOGY

This disclosure relates generally to retail pricing and, more particularly, to a system, method, and apparatus of automated reactive retail pricing through multilevel hierarchical regression.

### BACKGROUND

A retailer may have a variety of goals they wish to achieve, and may which to find an optimal price for a product to achieve those goals. These goals may include maximizing profit, or maximizing the volume of a product which generates store traffic and stimulates the sales of other products. The retailer may wish to avoid having a surplus of inventory beyond a certain date, such as a holiday, and may wish to find a pricing campaign to ensure all inventory is gone by the end of the holiday.

Traditional retail analytics can be slow to generate predictions, and even slower to test a model. The time between a decision being made at a retailer's management level and being implemented at the store level makes it difficult to refine a pricing model. Furthermore, tradition al retail analytics operate on a timescale which precludes the inclusion, and leveraging, of the effects of fast moving metrics (e.g. weather, news, social media, sudden competitor behavior, etc.) on product performance.

### SUMMARY

Disclosed are a system, method, and apparatus of automated reactive retail pricing through multilevel hierarchical regression. In one aspect, a method of a reactive retail pricing server includes obtaining a set of relevant data, creating a plurality of merchandising sets, and transforming the set of relevant data using a processor and a memory. The method further includes calculating coefficients for a group model, performing a reverse transformation on the coefficients, and determining whether the plurality of merchandising sets and the group model require refinement. The recommended pricing is solved, wherein retailer strategies, retailer goals, and price campaign parameters are applied as constraints. Finally, the method includes automatically calibrating the coefficients for at least one group model, and processing price campaign adjustments.

The methods and devices disclosed herein may be implemented in any means for achieving the various aspects, and may be executed in the form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is an exemplary network architecture including a reactive retail pricing system, according to one embodiment.

FIG. 2 is a schematic diagram of exemplary data processing devices that can be used to implement the methods and systems disclosed herein, according to one embodiment.

FIG. 3 is a schematic view of the reactive retail pricing server of FIG. 1, according to one embodiment.

FIG. 4 is a process flow for providing automated reactive retail pricing, according to one embodiment.

FIG. 5 illustrates a collection of merchandising sets, according to one embodiment.

FIG. 6 is a collection of user interface views for providing status updates, according to one embodiment.

FIG. 7 is a collection of user interface views for adjusting price campaigns, according to one embodiment.

Other features of the present embodiments will be apparent from the accompanying drawings and from the detailed description that follows.

### DETAILED DESCRIPTION

Example embodiments, as described below, may be used to provide a system, method, and apparatus of automated reactive retail pricing through multilevel hierarchical regression.

According to one embodiment, a method of a reactive retail pricing server includes obtaining a set of relevant data, creating a plurality of merchandising sets, and transforming the set of relevant data using a processor and a memory. The method further includes calculating coefficients for a group model, performing a reverse transformation on the coefficients, and determining whether the plurality of merchandising sets and the group model require refinement. The recommended pricing is solved, wherein retailer strategies, retailer goals, and price campaign parameters are applied as constraints. Finally, the method includes automatically calibrating the coefficients for at least one group model, and processing price campaign adjustments.

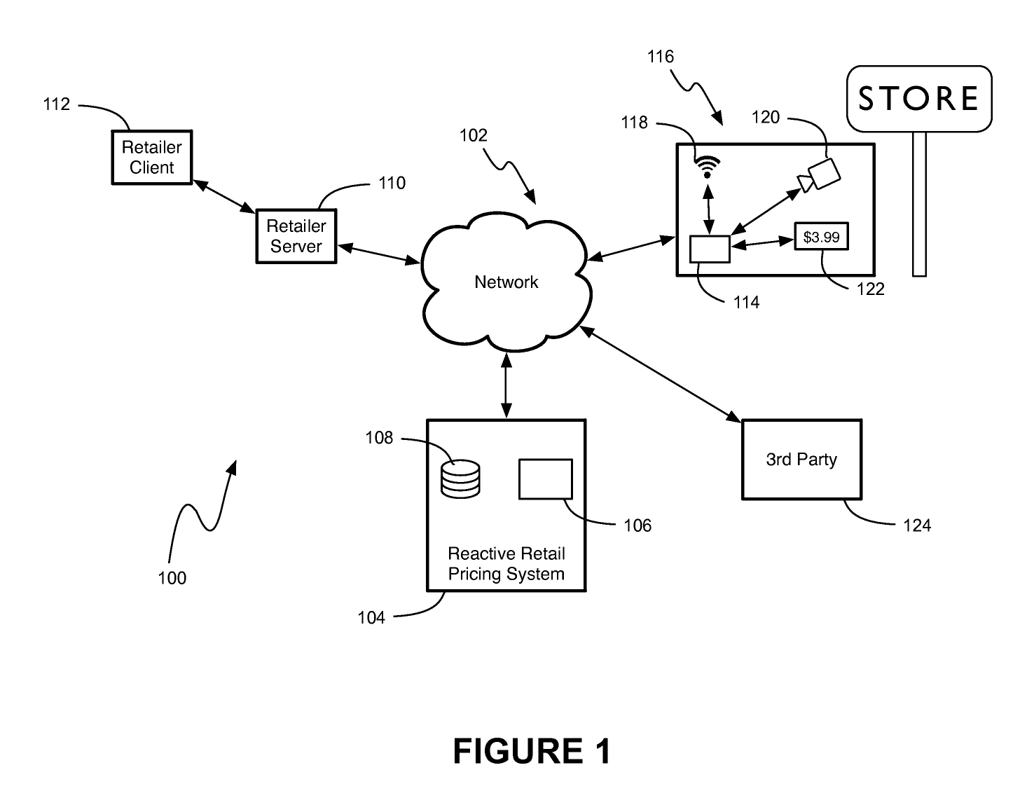

FIG. 1 illustrates exemplary network architecture 100, in accordance with one or more embodiments. As shown, network architecture 100 may comprise a reactive retail pricing system 104, a retailer server 110, a store server 114, and a third party server 124, all coupled to a network 102. In the context of the present network architecture 100, the network 102 may take any form including, but not limited to a local area network (LAN), a wireless network, a wide area network (WAN) such as the Internet, peer-to-peer network, etc. In other embodiments, network 102 may represent a plurality of networks.

Coupled to network 102 is reactive retail pricing system 104, which comprises a reactive retail pricing server 106. In other embodiments, reactive retail pricing system 104 may further comprise database 108. In the context of the present description, a reactive retail pricing system is a system which provides automated, optimized pricing for retailers based upon multilevel hierarchical regression modeling using a wide range of product and market attributes, and constrained to meet the goals and strategies of the retailer, in accordance with multiple embodiments. Multilevel hierarchical modeling is a generalization of linear and generalized linear modeling in which regression coefficients are themselves given a model, whose parameters are also estimated from data. A reactive retail pricing system may provide optimized pricing which is reactive to changes in circumstances, including, but not limited to, competitor behavior, weather, social media, performance in other markets, etc.

As shown, reactive retail pricing system 104 is communicatively coupled to retailer server 110 through network 102. In the context of the present description, a retailer server is a server which is communicatively coupled to a store server 114 in a retail location 116. In some embodiments, the retailer server may be used to collect sales and inventory data from retail locations, as well as distribute instructions to retail locations, the instructions including but not limited to pricing information, product descriptions, and/or marketing. In one embodiment, the retailer server may contain strategies, goals and constraints associated with that retailer. In another embodiment, such data may be stored within database 108.

In some embodiments, retailer client 112 may be communicatively coupled to reactive retail pricing system 104 through retailer server 110. In other embodiments, the retailer client 112 may be communicatively coupled to the reactive retail pricing system 104 while bypassing retailer server 110. In the context of the present description, a retailer client is a computing client which allows a user, such as a category manager, interface with the reactive retail pricing system 104. This client may be used to modify pricing parameters, as well as monitor the status of live price campaigns, in accordance with one embodiment.

In one embodiment, store server 114 may be communicatively coupled to one or more sources of data, which may include, but are not limited to, an inventory management system 118, and one or more cameras 120. In the context of the present description, an inventory management system is a system which can monitor inventory levels and sales, possibly in real-time. The inventory management system may utilize technologies including, but not limited to, optical machine-readable codes (e.g. barcodes, QR codes, etc.), wireless tracking, and/or radio-frequency identification (RFID) tags and readers.

Furthermore, the store server 114 may be communicatively coupled to a plurality of electronic shelf labels 112. In the context of the present description, an electronic shelf label refers to a device which can display product information, including a price. Electronic shelf labels may be modified through a computer interface, receiving updates via wired or wireless (e.g. infrared, visible light, radio, etc.) communications. Electronic shelf label 112 may utilize display technology including, but not limited to, LCD, o-LED, light emitting polymer, electrophoretic displays, electro-wetting displays, electro fluidic displays, cholestric displays, interferometric modulator displays, other forms of electronic paper, and/or bi-stable displays.

The reactive retail pricing system 104 is further communicatively coupled, through network 102, to one or more third party data servers 124. In various embodiments, the third party data servers may provide data used by the reactive retail pricing system to optimize retail pricing, including, but not limited to, social network data, weather, demographics, news, competitor behavior, market performance, product information, and/or any other information which may be associated with a phenomenon, event, or behavior which may influence retail performance. In other embodiments, some or all of this data may be generated within the reactive retail pricing system, and not obtained from a third party.

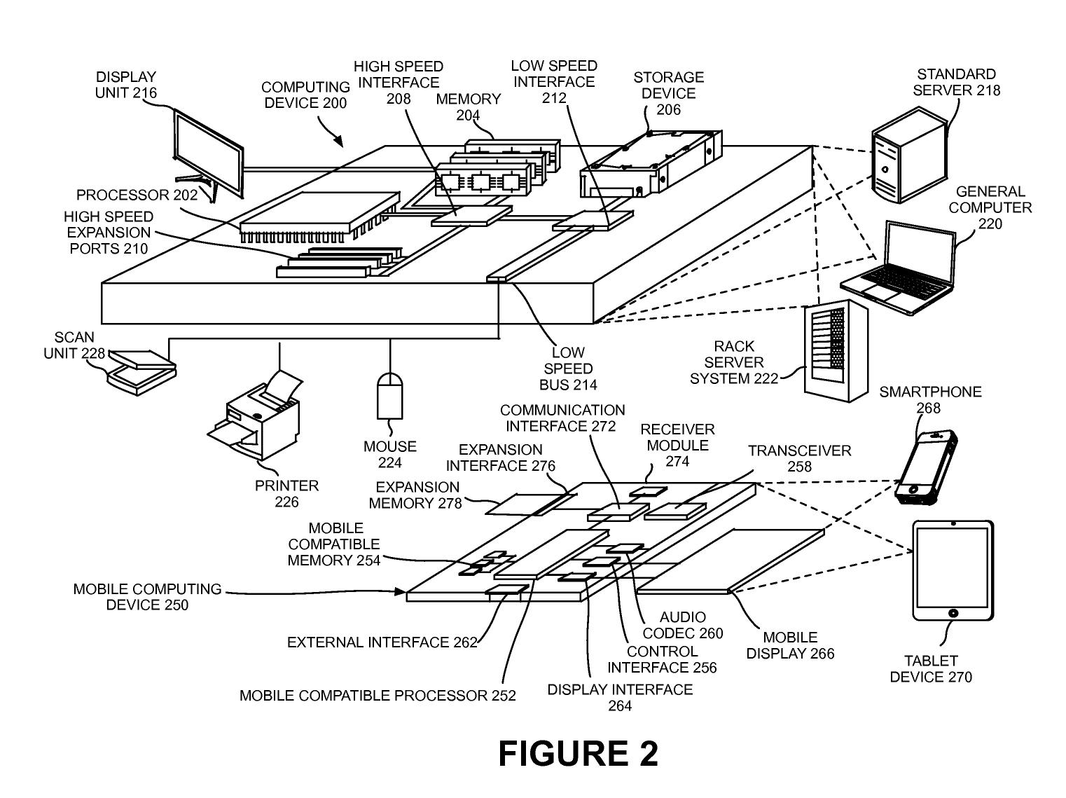

FIG. 2 shows a representative hardware environment that may be associated with the servers and/or clients of FIG. 1, according to one or more embodiments. FIG. 2 is a schematic of a computing device 200 and a mobile device 250 that can be used to perform and/or implement any of the embodiments disclosed herein. For example, in one or more embodiments, any of the one or more servers, such as reactive retail pricing server 106, retailer server 110, store server 114, and third party data server 124 may be the computing device 200. In addition, the retailer client 112 may be either the computing device 200 or the mobile device 250.

The computing device 200 may represent various forms of digital computers, such as laptops, desktops, workstations, personal digital assistants, servers, blade servers, mainframes, and/or other appropriate computers. The mobile device 250 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

The computing device 200 may include a processor 202, a memory 204, a storage device 206, a high speed interface 208 coupled to the memory 204 and a plurality of high speed expansion ports 210, and a low speed interface 212 coupled to a low speed bus 214 and a storage device 206. In one embodiment, each of the components heretofore may be inter-coupled using various buses, and may be mounted on a common motherboard and/or in other manners as appropriate. The processor 202 may process instructions for execution in the computing device 200, including instructions stored in the memory 204 and/or on the storage device 206 to display a graphical information for a GUI on an external input/output device, such as a display unit 216 coupled to the high speed interface 208. In other embodiments, multiple processors and/or multiple buses may be used, as appropriate, along with multiple memories and/or types of memory. Also, a plurality of computing devices 200 may be coupled with, with each device providing portions of the necessary operations (e.g., as a server bank, a group of blade servers, and/or a multi-processor system).

The memory 204 may be coupled to the computing device 200. In one embodiment, the memory 204 may be a volatile memory. In another embodiment, the memory 204 may be a non-volatile memory. The memory 204 may also be another form of computer-readable medium, such as a magnetic and/or an optical disk. The storage device 206 may be capable of providing mass storage for the computing device 200. In one embodiment, the storage device 206 may be comprised of at least one of a floppy disk device, a hard disk device, an optical disk device, a tape device, a flash memory and/or other similar solid state memory device. In another embodiment, the storage device 206 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described herein. The instructions may be stored in at least one of the memory 204, the storage device 206, a memory coupled to the processor 202, and/or a propagated signal.

The high speed interface 208 may manage bandwidth-intensive operations for the computing device 200, while the low speed interface 212 may manage lower bandwidth-intensive operations. Such allocation of functions is exemplary only. In one embodiment, the high-speed interface 208 may be coupled to at least one of the memory 204, the display unit 216 (e.g., through a graphics processor and/or an accelerator), and to the plurality of high speed expansion ports 210, which may accept various expansion cards. In the embodiment, the low speed interface 212 may be coupled to at least one of the storage device 206 and the low-speed bus 214. The low speed bus 214 may be comprised of a wired and/or wireless communication port (e.g., a Universal Serial Bus (“USB”), a Bluetooth® port, an Ethernet port, and/or a wireless Ethernet port). The low speed bus 214 may also be coupled to at least one of scan unit 228, a printer 226, a keyboard, a mouse 224, and a networking device (e.g., a switch and/or a router) through a network adapter. In various embodiments, display unit 216 may comprise touchscreen technology, and serve as an input device to computing device 200.

The computing device 200 may be implemented in a number of different forms, as shown in the figure. In one embodiment, the computing device 200 may be implemented as a standard server 218 and/or a group of such servers. In another embodiment, the computing device 200 may be implemented as part of a rack server system 222. In yet another embodiment, the computing device 200 may be implemented as a general computer 220 such as a laptop or desktop computer. Alternatively, a component from the computing device 200 may be combined with another component in a mobile device 250. In one or more embodiments, an entire system may be made up of a plurality of computing devices 200 and/or a plurality of computing devices 200 coupled to a plurality of mobile devices 250.

In one embodiment, the mobile device 250 may comprise at least one of a mobile compatible processor 252, a mobile compatible memory 254, and an input/output device such as a mobile display 266, a communication interface 272, and a transceiver 258, among other components. The mobile device 250 may also be provided with a storage device, such as a microdrive or other device, to provide additional storage. In one embodiment, at least one of the components indicated heretofore are inter-coupled using various buses, and several of the components may be mounted on a common motherboard.

The mobile compatible processor 252 may execute instructions in the mobile device 250, including instructions stored in the mobile compatible memory 254. The mobile compatible processor 252 may be implemented as a chipset of chips that include separate and multiple analog and digital processors. The mobile compatible processor 252 may provide, for example, for coordination of the other components of the mobile device 250, such as control of user interfaces, applications run by the mobile device 250, and wireless communication by the mobile device 250.

The mobile compatible processor 252 may communicate with a user through the control interface 256 and the display interface 264 coupled to a mobile display 266. In one embodiment, the mobile display 266 may be at least one of a Thin-Film-Transistor Liquid Crystal Display (“TFT LCD”), an Organic Light Emitting Diode (“OLED”) display, and another appropriate display technology. The display interface 264 may comprise appropriate circuitry for driving the mobile display 266 to present graphical and other information to a user. Furthermore, in various embodiments, mobile display 266 may include touchscreen technology receptive to user input. The control interface 256 may receive commands from a user and convert them for submission to the mobile compatible processor 252. In addition, an external interface 262 may be provide in communication with the mobile compatible processor 252, so as to enable near area communication of the mobile device 250 with other devices. External interface 262 may provide, for example, for wired communication in some embodiments, or for wireless communication in other embodiments, and multiple interfaces may also be used.

The mobile compatible memory 254 may be coupled to the mobile device 250. The mobile compatible memory 254 may be implemented as at least one of a volatile memory and a non-volatile memory. The expansion memory 278 may also be coupled to the mobile device 250 through the expansion interface 276, which may comprise, for example, a Single In Line Memory Module (“SIMM”) card interface. The expansion memory 278 may provide extra storage space for the mobile device 250, or may also store an application or other information for the mobile device 250. Specifically, the expansion memory 278 may comprise instructions to carry out the processes described above. The expansion memory 278 may also comprise secure information. For example, the expansion memory 278 may be provided as a security module for the mobile device 250, and may be programmed with instructions that permit secure use of the mobile device 250. In addition, a secure application may be provided on the SIMM card, along with additional information, such as placing identifying information on the SIMM card in a non-hackable manner.

The mobile compatible memory 252 may comprise at least one of a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on at least one of the mobile compatible memory 254, the expansion memory 278, a memory coupled to the mobile compatible processor 252, and a propagated signal that may be received, for example, over the transceiver 258 and/or the external interface 262.

The mobile device 250 may communicate wirelessly through the communication interface 272, which may be comprised of a digital signal processing circuitry. The communication interface 272 may provide for communications using various modes and/or protocols, such as, at least one of: a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol. Such communication may occur, for example, through the radio-frequency transceiver 258. In addition, short-range communication may occur, such as using a Bluetooth®, Wi-Fi, and/or other such transceiver. In addition, a GPS (“Global Positioning System”) receiver module may provide additional navigation-related and location-related wireless data to the mobile device 250, which may be used as appropriate by a software application running on the mobile device 250.

The mobile device 250 may also communicate audibly using an audio codec 260, which may receive spoken information from a user and convert it to usable digital information. The audio codec 260 may likewise generate audible sound for a user, such as through a speaker (e.g., in a handset of the mobile device 250). Such a sound may comprise a sound from a voice telephone call, a recorded sound (e.g., a voice message, a music files, etc.) and may also include a sound generated by an application operating on the mobile device 250.

The mobile device 250 may be implemented in a number of different forms, as shown in the figure. In one embodiment, the mobile device 250 may be implemented as a smartphone 268. In another embodiment, the mobile device 250 may be implemented as a personal digital assistant (“PDA”). In yet another embodiment, the mobile device, 250 may be implemented as a tablet device 270.

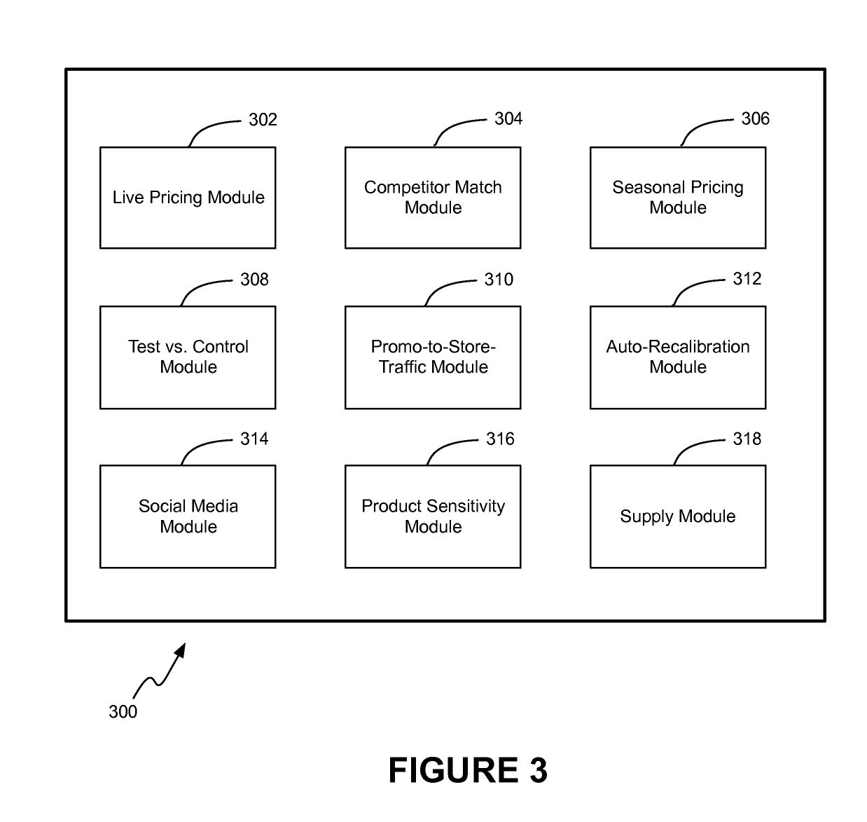

FIG. 3 shows a server 300 for providing automated reactive retail pricing, according to one or more embodiments. As an option, the server 300 may be implemented in the context of the architecture and environment of the previous Figures or any subsequent Figure(s). Of course, however, the server 300 may be carried out in any desired environment. It should also be noted that the aforementioned definitions may apply during the present description.

In various embodiments, server 300 may function as part of a reactive retail pricing system (e.g. reactive retail pricing server 106 of reactive retail pricing system 104, etc.). As shown, server 300 comprises a live pricing module 302. In the context of the present description, a live pricing module provides optimal retail prices for one or more products, consistent with strategies (e.g. undercutting a particular competitor in a particular market, etc.), goals (e.g. maximizing profit, maximizing volume of an “image” product, etc.), and constraints (e.g. never sell one brand below another, etc.). In one embodiment, the live pricing module determines retail prices by optimizing a statistical model representing one or more products in one or more markets, with possible solutions being bound by the strategies, goals, and constraints associated with that retailer. In various embodiments, the model may be a multilevel hierarchical model based upon a regression analysis using a plurality of attributes. Attributes may include, but are not limited to, point of sale location, inventory, product cost, product attributes (e.g. size, weight, color, flavor, etc.), historical performance, overall market performance, demographics, store traffic, marketing, social media, news, weather, competitor behavior, and/or any other information which could possibly have a causal relationship with product sales and/or demand. These attributes will determine the coefficients of the multilevel hierarchical model.

In various embodiments, the live pricing module is able to provide updated optimal prices based on updated attribute data, and do so quickly. This may be done with turn-around times much smaller than those associated with traditional retail consulting and pricing recommendations. Once a model has been defined for a retailers line of products and retail locations/zones, the live pricing model may provide updated prices quickly, in reaction to data provided by the retailer and/or other parties.

Furthermore, in various embodiments, the live pricing module is able to automatically publish the optimized retail prices. For example, in one embodiment, a table of recommended prices may be automatically sent to a retailer (e.g. sent to the retailer server, etc.) or to a store (e.g. sent to a store server, etc.). In another embodiment, the live pricing module may be able to trigger an automatic update of electronic shelf labels in one or more retail locations, such that they reflect the most recent optimized prices. As an option, a retailer may define limits to how much the live pricing module may alter prices on electronic shelf labels without user confirmation.

In one embodiment, server 300 may further comprise a competitor match module 304. In the context of the present description, a competitor match module allows for the introduction of competitor behavior as a constraint to the optimization of the price model used by the live pricing module, such that the optimized prices may be made reactive to competitor behavior. In one embodiment, the competitor match module may allow the retailer to determine who the top competitors are for a particular product or set of products, within a particular market or zone. This may be accomplished by modeling location, product, and competitor price using current and historical data. For example, the module may determine that the price for a particular class of products can be 10% higher than a particular competing retailer in one city, but must be within 2% in another. In another embodiment, the degree of effect a competitor may have with respect to a certain product in a certain market may be assigned a numerical value, to aid in the identification in the most important competitive pricing battles to fight.

Once competitors have been identified or chosen, the competitor match module provides one or more external constraints to the solver used by the live pricing module. In this way, the live pricing module is able to provide pricing recommendations that react to competitor behavior, with little delay.

As shown, server 300 may comprise a seasonal pricing module 306, in accordance with one embodiment. In the context of the present description, a seasonal pricing module may allow a retailer to specify a target endpoint condition for one or more products. In the context of the present description, a target endpoint condition refers to the product inventory at a specific date, in a specific market or zone. For example, in one embodiment, the seasonal pricing module may be used to determine what price or series of price campaigns will result in a certain volume of sales by a certain date. As a specific example, this module may be used to determine an optimal series of prices to ensure maximum profits during the period preceding Christmas, while resulting in little or no surplus inventory on Christmas Day. As an option, considerations such as product returns and product salvage may also be taken into account. In various embodiments, the seasonal pricing module may determine an ideal price to achieve a particular endpoint condition by solving a series of equations based on the multilevel hierarchical pricing model. In one embodiment, the seasonal pricing module may periodically update the projection. For example, if, after the holiday retail campaign has begun, sales volume for a particular product are not matching the projection, the seasonal pricing module may recommend a new price to get the volume back on track to hitting the predefined endpoint. As another example, the seasonal pricing module may be used to predict and monitor “holiday lift”, the bump up in sales some products experience in the time leading up to a holiday. If the lift for a product is not in line with the projections, this module may recommend a new price campaign.

In various embodiments, server 300 may comprise a test vs. control module 308. In the context of the present description, a test vs. control module may identify ideal test and control groups for a desired retail experiment. In one embodiment, after the user has specified the desired size of the groups (e.g. 5 stores, 20 stores, etc.), the test vs. control module may recommend which stores to use in which group, based upon the coefficients generated in the creation of the multilevel hierarchical model used by the live pricing module. Through a statistical analysis of at least some of these coefficients, the test vs. control module is able to assemble two groups based on many of the attributes which affect the pricing model, many of which could be overlooked in using groups assembled based only on sales volume or seasonality. The results of a retail experiment run on test and control groups assembled in this manner may be more statistically reliable, and may provide better data for refining the pricing model or making executive decisions.

In another embodiment, server 300 may further comprise a promo-to-store-traffic module 310. In the context of the present description, a promo-to-store traffic module allows a retailer to define certain pricing actions to be taken based upon consumer traffic within a store. For example, in one embodiment, the promo-to-store module may prompt a retailer recommending a price reduction for a certain product in a certain store, based upon the number of people in a particular section of that store. In another embodiment, the retailer may authorize the promo-to-store to automatically modify prices within a predefined range, based upon store traffic. The retailer may be able to specify a set of conditions which must be satisfied before an automatic price change may occur, such as a particular inventory level, or a threshold price set by a local competitor.

In various embodiments, the promo-to-store-traffic module may obtain store traffic data from the retailer. For instance, the retailer may provide the module access to closed-circuit video feeds (e.g. the feed from camera 120, etc.); the module may use image recognition software to determine the number of customers in each section of a store. In some embodiments, this determination may be performed in near real-time. In another embodiment, the promo-to-store-traffic module may be able to trigger a device located in a store which can provide an aural and/or visual alert to customers that a price reduction has occurred in their proximity. As an option, this alert may be accomplished using the electronic shelf labels.

As shown, server 300 may further comprise an automatic recalibration module 312. In the context of the present description, an automatic recalibration module is able to automatically refine the multilevel hierarchical model used by the live pricing module, using data obtained since the last recalibration of the model coefficients. In one embodiment, the model may be recalibrated on a daily basis, enabling the live pricing module to react quickly to changes in the market or competitor behavior.

In various embodiments, server 300 may comprise a social media module 314. In the context of the present description, a social media module may provide a retailer with real-time feedback as to whether or not a promotion is working, and why. For example, in one embodiment, a retailer may provide the social media module with an identifier (e.g. a hash tag, etc.) associated with the marketing surrounding a promotion. The social media module may monitor the amount of activity surrounding the provided identifier, and provide that data for incorporation into other modules, such as the live pricing module, the promo-to-store-traffic module, the seasonal pricing module, or any other module.

In another embodiment, the social media module may employ technologies such as text parsing, natural language processing, machine learning, named entity recognition, sentiment analysis, and/or any other natural language analysis technology to mine social media streams for information concerning retailer promotions, products, competitor behavior, and/or other events and trends which may affect a retailer's sales. In still another embodiment, the social media module may be employed to find potential correlations between data culled from social media streams and instances where a products sales over- or underperform compared to the model based projection.

In one embodiment, server 300 may further comprise a product sensitivity module 316. In the context of the present description, a product sensitivity module may be used to define what role a product or category or subcategory of products should play. In one embodiment, this module may be used to assist a retailer in selecting the role different product categories should play (e.g. developing market share, building and maintaining image, a profit driver, etc.). The module may make recommendations based on metrics derived from some or all of the data gathered by the live pricing module, such as price elasticity, sales volume, etc. In another embodiment, the product sensitivity module may be used to generate a set of boundary conditions which represent a retailer's selected role definitions; said boundary conditions may be subsequently placed upon the solver used to determine optimal pricing while ensuring the retailer's product strategies and goals are implemented.

In yet another embodiment, server 300 may comprise a supply module 318. In the context of the present description, a supply module may be used to take advantage of product supply-related opportunities to achieve the retailer's specified goals. For example, in one embodiment, the supply module may determine that the current price campaign, while successful in one market, is not performing well in a nearby market. The module may recognize a profit opportunity in shifting some inventory from the less active market to the market where the campaign is performing well. As another specific example, the supply module may be used to assist the retailer in deciding on an optimal price for a product which the retailer has an opportunity to obtain at a discount if purchased in sufficient quantities. The module may assist the retailer in determining whether the optimal price associated with such a volume would make that particular deal a gain or a loss.

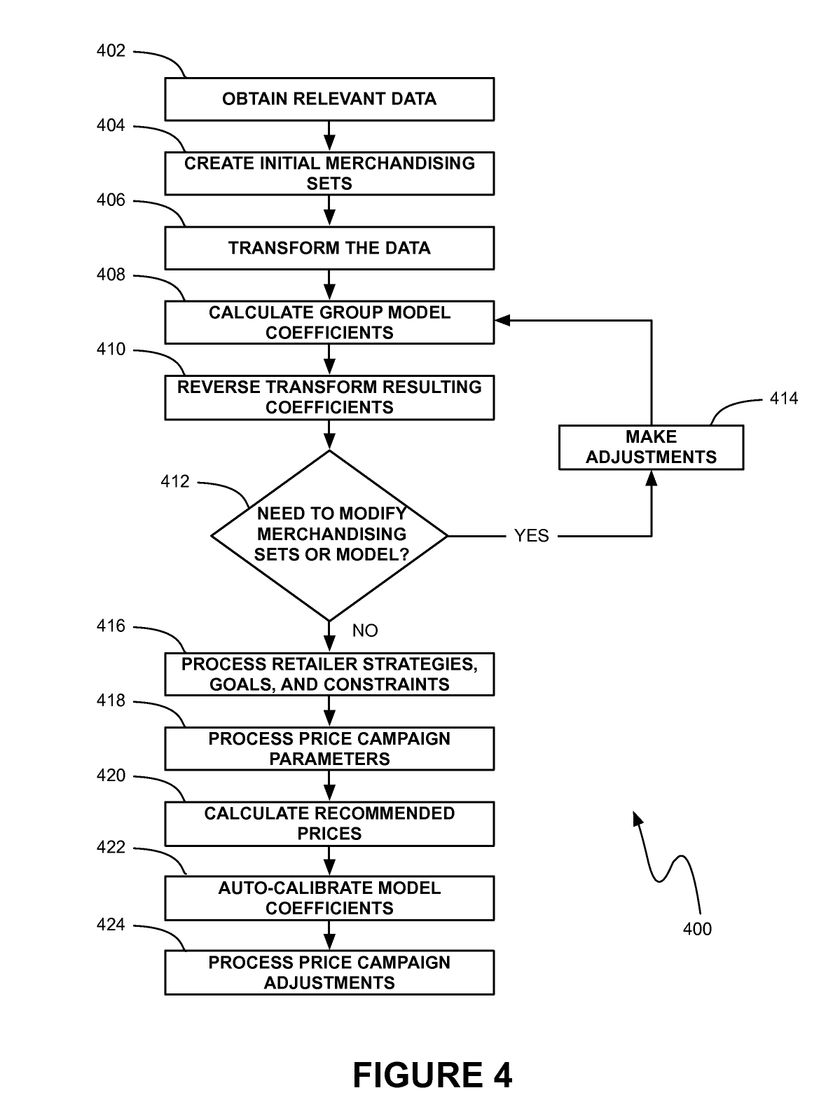

FIG. 4 shows a method for providing automated reactive retail pricing, according to one or more embodiments. As an option, the method 400 may be implemented in the context of the architecture and environment of the previous Figures or any subsequent Figure(s). Of course, however, the method 400 may be carried out in any desired environment. It should also be noted that the aforementioned definitions may apply during the present description.

As shown, relevant data is obtained. See operation 402. In various embodiments, the providing of automatic reactive retail pricing is accomplished by creating a multilevel hierarchical model based upon a regression analysis using relevant data. In the context of the present description, relevant data refers to any data which may describe an event, phenomenon, item, product, geographic location or region, market, entity, trend, campaign, or other object or activity which may affect the sales of a product. Examples of relevant data may include, but are not limited to, point of sale returns, store location, store traffic, store video feeds, store inventory, unit cost, product attributes (e.g. size, weight, color, flavor, material, etc.), historical performance, market activity, performance of similar products, competitor behavior, competition pricing, competitor history, social media data, weather data, news reports, market demographics, census data, and/or any other data which may possibly have a relationship to the sales of a product. Some of the data may be obtained in real-time, while other data may be of a historical nature.

In some embodiments, some or all of the relevant data may be provided by the retailer. For example, in one embodiment, the retailer may provide data concerning sales, inventory, store traffic, historical performance, and historical performance to a reactive retail pricing system 104 through the retailer server 110. In other embodiments, the reactive retail pricing system may obtain some or all of the relevant data from a third party data server 124. In still other embodiments, the reactive retail pricing system may obtain relevant data from consumers. For example, data concerning the pricing and promotions of competitors may be obtained by incentivizing consumers to scan their receipts, and submitting the image for data extraction. In yet another embodiment, some or all of the relevant data may be generated internally by the entity operating the reactive retail pricing system. In accordance with one embodiment, the reactive retail pricing system may store the collection of relevant data in a database 108.

Over time, the relevant data is updated. In one embodiment, some portions of the relevant data may be more dynamic than others. For example, data such as market demographics may be updated on a monthly basis, while store inventory may be updated on a daily, or even hourly basis.

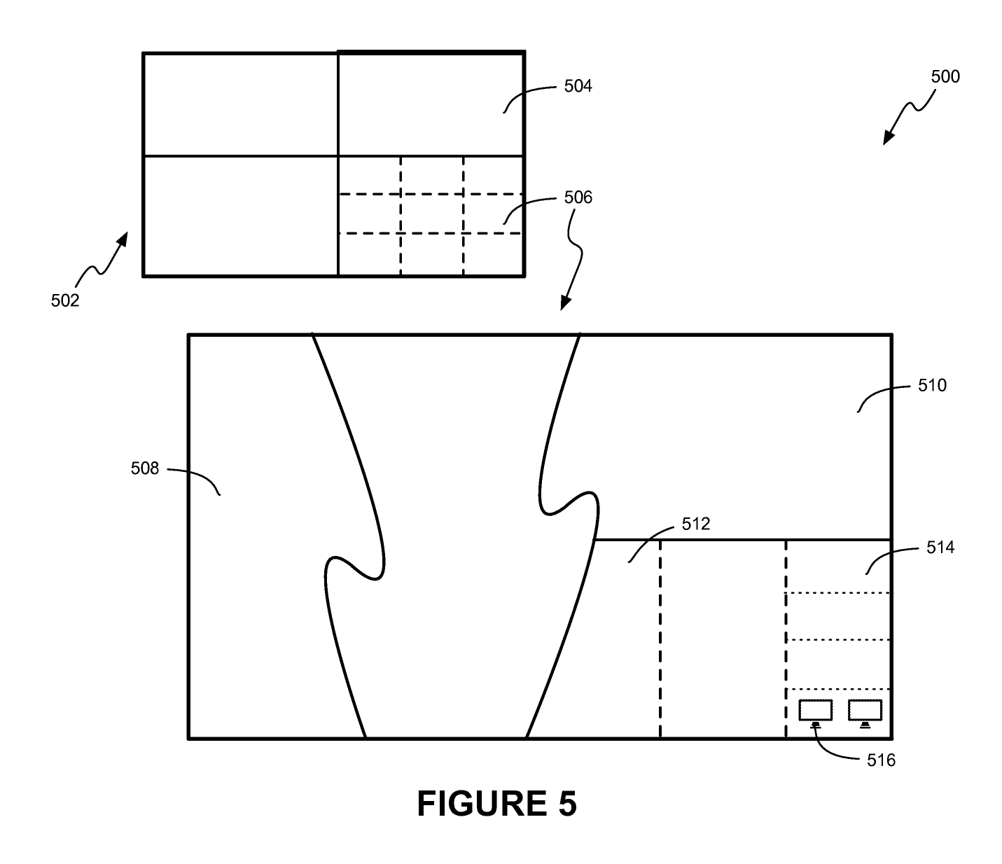

As shown, initial merchandising sets are created. See operation 404. In the context of the present description, merchandising sets refer to the hierarchical levels of partitioning given to a collection of products for which a retailer is seeking optimal pricing. See, for example, FIG. 5. In various embodiments, the collection of products is partitioned into groups of different levels of granularity, with each level being referred to as a merchandising set, and with each product having membership in a group belonging to each of the merchandising sets. In some embodiments, the reactive retail pricing system makes use of four merchandising sets, where merchandising set 4 is the most granular, and merchandising set 1 is the least granular. As a specific example, merchandising set 4 could be composed of groups of 2 or 3 products, merchandising set 3 could be groups of 5 to 10 products, merchandising set 3 could be groups of 10 to 50 products, and merchandising set 4 could be groups of 50 to 200 products. In some embodiments, additional levels may be used; for example, individual items may be considered below merchandising set 4. Above merchandising set 1, consideration could be made for categories and subcategories, in line with a retailer's particular leadership structure. In other embodiments, fewer merchandising sets may be used.

In various embodiments, the group to which a product is assigned within each of the merchandising sets may depend upon a variety of factors. In one embodiment, group assignment may be made based upon how a product behaves over the course of a year, taking into consideration seasonality and price point. In another embodiment, products may be assigned to groups based upon the regression coefficients given to their respective models after a preliminary analysis using the relevant data. Specifically, the groups may be organized within each merchandising set such that at least a subset of the coefficients assigned to the models belonging to group members are similar. As an option, some coefficients may be given greater weight than others when assigning groups; the assignment of weight may depend upon which merchandising set is being organized. For example, product color may be less important in the grouping of merchandising set 1 than it is in set 4. In some instances, one or more coefficients may be completely disregarded when organizing the merchandising sets.

As shown, the relevant data is transformed. See operation 406. In various embodiments, some of the relevant data may be transformed to improve modeling accuracy. In the context of the present embodiment, transformation refers to the application of a mathematical function to a set of data, wherein that data is replaced with the transformed values. As a specific example, price change data may be transformed into the logarithm of the price change. In many embodiments, the transforming function is invertible. Examples of transformation functions include, but are not limited to, exponential, linear, logarithmic, reciprocal, square root, power, any combination of these, and/or any other mathematical function. A specific example of a transformation which may be performed is the deseasonalization of the data (e.g. the removal of seasonal effects on the sales volume, etc.). The choice of which transformation to use and what data to transform may depend upon the retailer and/or the particular set of products being analyzed.

As shown, the group model coefficients are calculated. See operation 408. Once the merchandising sets have been partitioned, model coefficients are calculated for each product group within each merchandising set, in accordance with one embodiment. Furthermore, these coefficients are calculated for each of the markets in which the retailer operates. The evaluation of the group coefficients may be performed for markets whose geographic granularity ranges from small (e.g. individual stores, etc.) to large (e.g. states, zones, etc.).

In various embodiments, the calculation of group model coefficients comprises the evaluation of a number of factors which exert an effect on sales volume for the group under consideration, given a base price. These effects may include, but are not limited to, competitor effects (primary and secondary), weather, store traffic (including gender effects), seasonality, holiday, and/or promotional effects.

Having accurate models describing each group within each merchandising set for each market facilitates making pricing recommendations for products for which there is little data. For example, in one embodiment, if there is insufficient historical performance for a particular item to capture seasonality, the coefficients of its group within merchandising set 4 (e.g. the next set of lower granularity, etc.) may be used instead.

As shown, the transformation of the resulting coefficients is reversed. See operation 410. In various embodiments, depending on what transformations were preformed before group coefficient calculations, the resulting coefficients may need to be transformed again to return the coefficients to their original phase space. As a specific example, the resulting coefficients may be “reseasonalized”, by applying the seasonality index removed in the earlier transformation, making the coefficients reflect seasonal changes.

As shown, it is determined if the merchandising sets or models need to be modified. See determination 412. As previously explained, properly formed groups within merchandising sets facilitates the making of assumptions in the absence of sufficient relevant data for a product. In various embodiments, the determination as to whether or not the merchandising sets and/or the model are properly formed is made using a variety of metrics. For example, in one embodiment, the determination may be made using backcasting (e.g. seeing if the model predicts previously observed behavior when given previously recorded relevant data, etc.). In another embodiment, the determination may be made using p-value.

If the result of determination 412 is that the merchandising sets or model need to be modified, adjustments are made. See operation 414. In accordance with one embodiment, portions of one or more merchandising sets may be reorganized based upon deficiencies discovered through the previously discussed metrics. In another embodiment, more systemic problems may be addressed by modifying which coefficients are included in the model, and which are to be ignored. After adjustments have been made, the process is repeated by recalculating model coefficients (e.g. operation 408). Through an iterative process, the model for the individual products as well as the groups within the merchandising sets is refined.

In some embodiments, the adjustments made to the merchandising sets and/or model may be made based upon human intuition and experience (e.g. receiving user input, etc.). In other embodiments, the composition of the groups and the structure of the model may be optimized programmatically. For example, in one embodiment, stochastic optimization (e.g. simulated annealing, genetic algorithms, reactive search optimization, etc.) may be employed.

As shown, the retailer's strategies, goals, and constraints are processed. See operation 416. In one embodiment, a retailer may specify various strategies, goals, and constraints with respect to the pricing of their products. These specifications may be made on a product category or sub-category level, depending on how the retailer leadership is organized (e.g. assignment of executives or managers to oversee subsets of the retail, etc.). In one embodiment, this operation may be performed, at least in part, by the competitor match module, the seasonal pricing module, the live pricing module, and/or any other module of the reactive retail pricing system.

In the context of the present description, goals refer to a particular outcome that is desired. Examples include, but are not limited to, maximizing profits for a product category, maximizing sales volume of an “image” product to drive up other sales, etc. In the context of the present description, strategies refer to a desired method of obtaining a desired outcome. Examples include, but are not limited to, undercutting a particular competitor in a particular market, ensuring pricing stays within a certain percentage of a competitor, etc. In the context of the present description, constraints refer to conditions which must be satisfied by any price campaign which is generated. Examples include, but are not limited to, ensuring the price of one brand never exceeds that of another, product inventory must not exceed a certain amount immediately after a holiday, etc. In many embodiments, these specified strategies, goals, and constraints do not modify the model, but rather place boundaries on the possible solutions to the system of equations that describe the products and their price.

As shown, the price campaign parameters are processed. See operation 418. In the context of the present description, price campaign parameters describe the bounds of a particular effort toward optimizing pricing. Example parameters may include, but are not limited to, campaign duration, maximum allowed price change without human verification, participating markets, and/or alert thresholds (e.g. alert a user if a competitor enters price territory outside the allowed price boundaries, etc.).

In some embodiments, price campaign parameters may include whether or not the use of certain tools is allowed in working towards the retailers goals. For example, in one embodiment, a price campaign parameter may be whether not automatic price alterations can be made based upon store traffic. See the previous discussion of the promo-to-store-traffic module. In another embodiment, a price campaign parameter may be whether or not price recommendations may take into account external influences described by particular relevant data, which may include but are not limited to, social media, weather, and news reports. As a specific example, if a price campaign has allowed the use of weather data, a recommended price may not be abandoned due to low sales volume when a heavy rainstorm is taken into account. As another example, pricing of certain products may be automatically modified depending upon the temperature.

As shown, the recommended prices are calculated. See operation 420. This operation would be performed by the live pricing module of a reactive retail pricing system, as previously discussed.

As shown, the model coefficients are automatically calibrated. See operation 422. As time goes on, and more relevant data is collected, the model coefficients may be periodically recalculated, in accordance with one embodiment. In one embodiment, this is done with a process identical to that used in earlier operations, such as 406 through 414. If a retailer desires the modeling to consider additional data, such as a new marketing campaign, the model may need to be modified.

As shown, price campaign adjustments are processed. See operation 424. In various embodiments, as a price campaign continues, the retailer may be given progress reports indicating whether the campaign is performing as expected. If the campaign is underperforming, or if the retailer desires to try something different, the campaign may be modified; such modifications may include adding, removing, or changing some or all of the strategies, goals, and constraints. In some embodiments, the retailer may be provided with tools to assist in making modifications to the price campaign, which may include, but are not limited to, the test vs. control module, and the purchasing module.

FIG. 5 illustrates a collection of merchandising sets, according to one or more embodiments. As an option, the collection of merchandising sets 500 may be implemented in the context of the architecture and environment of the previous Figures or any subsequent Figure(s). Of course, however, the collection of merchandising sets 500 may be carried out in any desired environment. It should also be noted that the aforementioned definitions may apply during the present description.

In various embodiments, a retailer's products are organized in a plurality of merchandising sets, each set containing all products and partitioned with varying degrees of granularity. See, for example, the merchandising sets illustrated in FIG. 5. The complete collection of products is represented by collection 502, which is divided into categories 504 and sub-categories 506. In various embodiments, the use of categories and subcategories may depend upon how the leadership of the retailer is organized. A subcategory is partitioned into groups 508 which make up merchandising set one. Each group 508 is partitioned into groups 510 which make up merchandising set two. Groups 510 are partitioned into groups 512, which are further partitioned into groups 514. These groups make up merchandising sets three and four, respectively. Finally, groups 514 are made up of individual products, which represent the highest degree of granularity, in accordance of one embodiment. In some embodiments, the various groups which make up each merchandising set may be assigned a name.

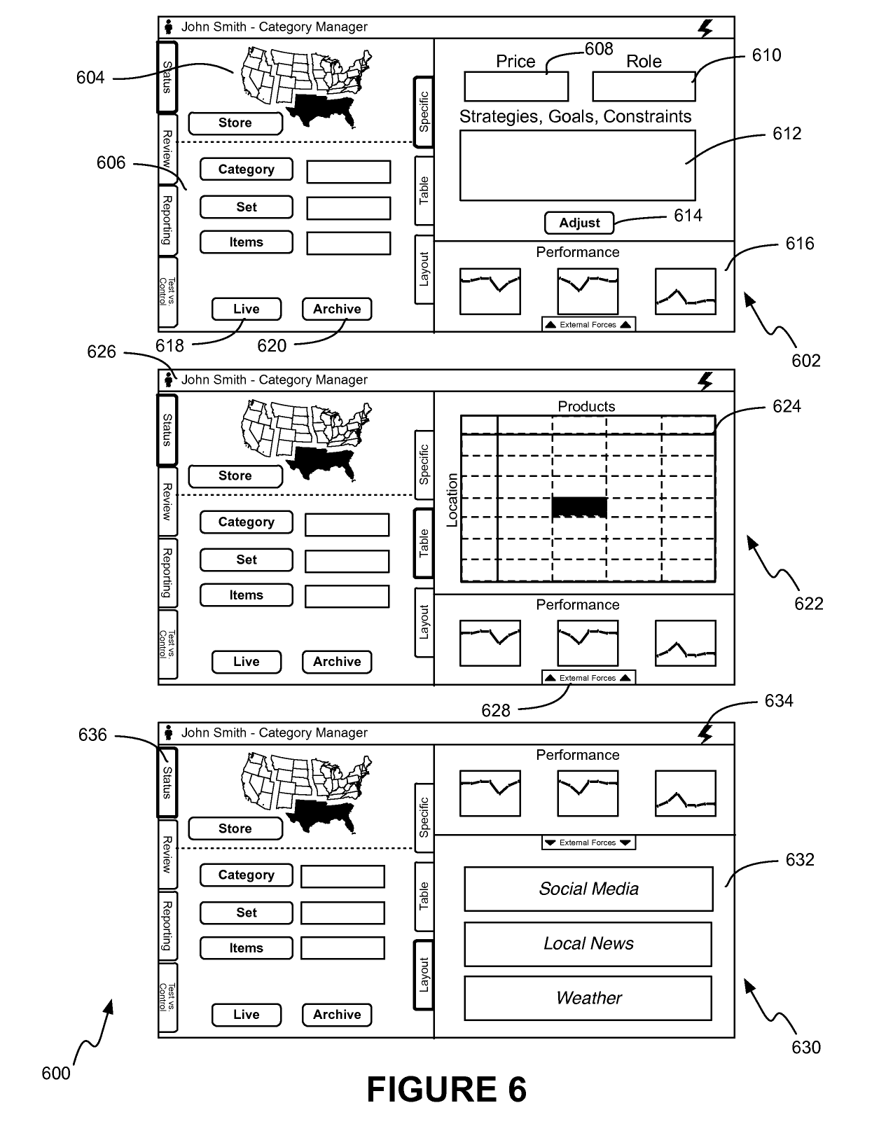

FIG. 6 shows a collection of user interfaces for providing status updates, according to one or more embodiments. As an option, the collection of user interfaces 600 may be implemented in the context of the architecture and environment of the previous Figures or any subsequent Figure(s). Of course, however, the collection of user interfaces 600 may be carried out in any desired environment. It should also be noted that the aforementioned definitions may apply during the present description.

In various embodiments, user interface 602 may be used to provide a user a detailed overview of a price campaign as defined for one or more products in one or more markets, in accordance with one embodiment. As shown, the user interface 602 may include a market selection element 604. In the context of the present description, a market selection element refers to a user interface element which allows the user to specify one or more markets pertinent to the retailer. In one embodiment, a map of all markets, broken into zones, may be presented; a user may select one or more zones using said map. Furthermore, the market selection element 604 may include a button or drop down menu to specify one or more stores located within the indicated zones.

As shown, user interface 602 may include an product selection element 606. In the context of the present description, a product selection element refers to a user interface element which allows a user to specify one or more retail products. As an option, entire merchandising set groups, or even categories and sub-categories, may be specified through product selection element 606.

In various embodiments, user interface 602 may include text fields 608 and 610, which indicate the prices and roles associated with the specified products in the specified markets for the price campaign currently being displayed. A user may select whether to view the current price campaign or a previous campaign using buttons 618 and 620, respectively. In one embodiment, if multiple products and/or markets have been specified, a range of prices and/or list of roles may be listed, which encompass all products and markets specified.

In one embodiment user interface 602 may also include a text field 612 to indicate the strategies, goals, and constraints associated with the specified products and markets. In the case of multiple products and/or markets, the displayed strategies, goals, and/or constraints may be grouped and ordered by number of items/markets represented by the group. As a specific example, a strategy common to most of the specified products may be listed at the top of the text field, while a strategy which only pertains to a few products may be near the bottom. As an option, the groups and items within text field 612 may be collapsible.

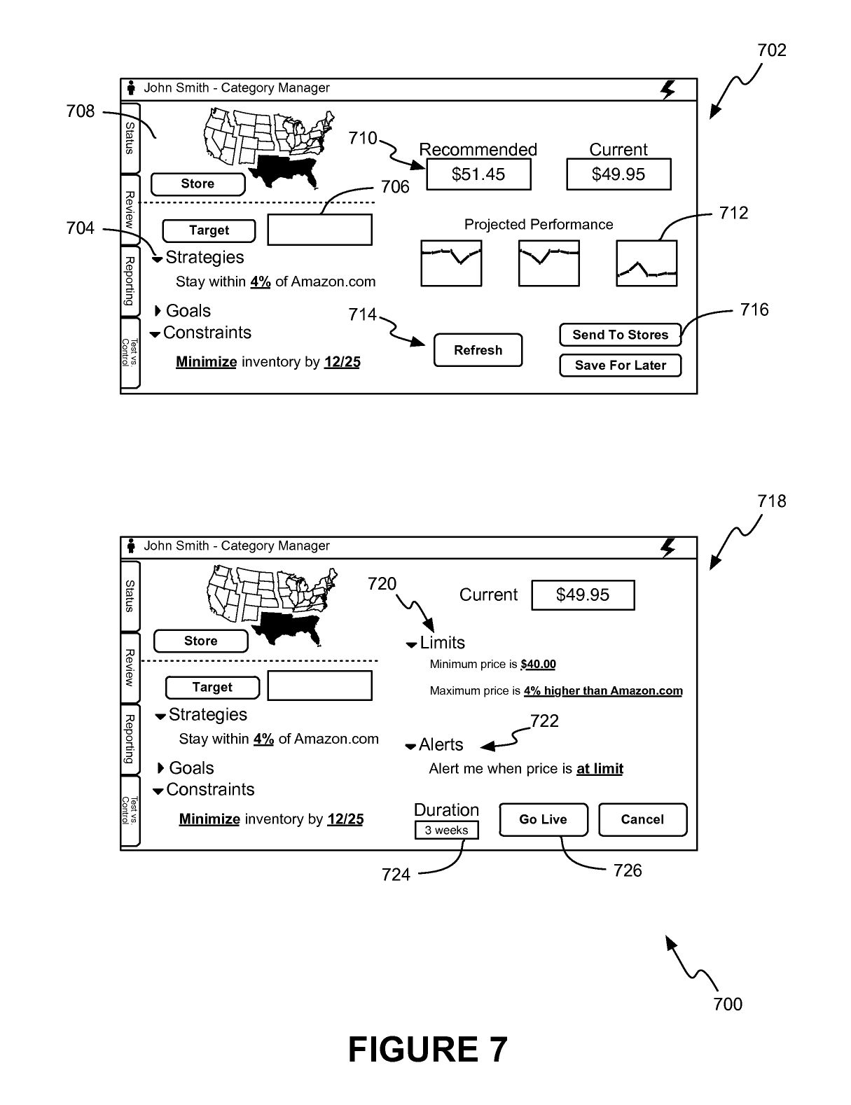

In various embodiments, user interface 602 may include an adjust button 614 which allows the user to adjust the parameters of the price campaign for the specified products and markets. In one embodiment, the user may be presented with user interface 702 of FIG. 7. In some embodiments, this button may be inoperable if the collection of products and/or markets specified are not governed by the same set of strategies, goals, and constraints and the user 626 does not have permission to make a new definition. For example, a category manager may not have sufficient privileges to redefine the strategies set by a higher level retail executive, but may be able to make small adjustments within those set strategies. On the other hand, that higher level retail executive may be able to redefine the strategies, goals, and constraints for any set of products and markets, and would thus be able to activate the adjust button 614.

As shown, user interface 602 includes a performance reporting element 616, in accordance with one embodiment. The performance reporting element 616 indicates to the user at least one of: profit, revenue, and/or volume associated with the specified products and markets. The performance reporting element may represent the information in a variety of forms, including, but not limited to, graphs, tables, icons, colors, sparklines, numerical values, etc. In some embodiments, reporting element 616 may indicate actual performance as well as what performance was projected. As an option, the projected future performance may also be indicated. In one embodiment, the user may be able to change the range of time for which performance is being reported.

In various embodiments, user interface 622 may be used to provide a user with a table overview of a price campaign as defined for one or more products in one or more markets, in accordance with one embodiment. As shown, the user interface 622 includes a table 624 which displays the recommended prices for the specified products in the specified markets. As an option, the performance reporting element may display the past and/or projected performance of the products/markets associated with one or more table cells selected by the user.

As shown, reporting user interfaces such as user interface 622 may indicate a user identity 626 and an associated role. In various embodiments, a retailer may associate a set of permissions with a role. For example, a vice president may have permission to completely modify a price campaign, defining entirely new strategies, goals and constraints, while a category manager may only be allowed to make small quantitative modifications to how a particular strategy, goal, or constraint is implemented. Furthermore, a user may be restricted in which products or markets they are able to access and/or modify. In some embodiments, if a user attempts to take an action which is beyond their given privileges, they may be prompted whether they wish to seek permission from a user with sufficient privileges. Said privileged user would then be prompted with the proposed action, and given a chance to approve or deny.

In various embodiments, reporting user interfaces such as user interface 622 may include an external forces button 628 which, when selected, provides information about potential external influence through an interface such as user interface 630. As shown, user interface 630 includes an external forces reporting element 632, which provides a user with information that may have had or will have an influence on the performance of specified products and markets. For example, in one embodiment, the user may be provided with social media trends, local news events, and weather associated with the specified products and markets. In another embodiment, external forces reporting element 628 may also report the behavior of a competitor. In some embodiments, the information being provided may be ordered based upon a determination of the likelihood that the information has had or will have an effect on sales performance. As an option, the ordering may be specific to potential influence on a particular portion of the performance reporting element (e.g. profit, revenue, volume, etc.) selected by the user. In one embodiment, the external forces reporting element may further provide a summary of what products and/or markets deviated from projected performance, and provide likely reasons for the deviation based on the external forces.

In various embodiments, reporting user interfaces such as user interface 622 may include alert icon 634. A user may be alerted to a number of events, including but not limited to, a competitor changing a price beyond a specified amount or percent, an aspect of a price campaign not achieving projected results, a goal not being met by a specified date, the introduction of new products in a market which a retailer does not sell, a need for new modeling (e.g. new dimensions to the relevant data, enough new products added to warrant a new model, etc.), an opportunity to capitalize on the success of a price campaign in a particular market (e.g. “Do you want to shift inventory from store X to store Y, with a projected increase in profit of Z?”, etc.), another user seeking approval for a change in a price campaign, and an automated price campaign seeking permission to adjust price beyond the allowed range. A user may be alerted in a variety of methods. In one embodiment, a user may be presented with an alert icon 634, or a prompt may be displayed, seeking user input. In another embodiment, a user may receive alerts via email, SMS, and/or push notification through a mobile application.

As shown, reporting user interfaces 600 may include a series of tabs 636 which allow a user to select different interactions with the system. Three exemplary reporting user interfaces have been shown. In another embodiment, a additional reporting interface may allow a user to visualize the arrangement of products on store shelves, with associated prices. The user may further be able to preview and modify what the electronic shelf labels 112 display. The user may also be presented with a store layout map, which may be overlaid with a store traffic heat map, indicating areas of the store where customers spend the most time.

Other interfaces which a user may select through tabs 636 include a review interface, a reporting interface, and a test vs. control interface. In various embodiments, a review interface may provide the user with the ability to review all currently live price campaigns to which they are allowed access. In one embodiment, a user may be informed as to which price campaigns are performing above, at, or below expected performance.

In various embodiments, a reporting interface allows a user to specify what kind of reports they desire, and how they want them delivered. For example, a user may specify that they want a report showing all automated price changes on a weekly basis, delivered via email. As another example, a user may specify that a summary of all live price campaigns, including performance as compared to projected performance, be provided as a PDF document on a fileserver. In one embodiment, a user may format and parameterize a report that is to be delivered to an executive on a regular basis.

A test vs. control interface allows a user to utilize a test vs. control module of a reactive retail pricing system, in accordance with one embodiment. Through this interface, a user may specify an experiment size (e.g. 5 store, 10 stores, etc.); after the creates ideal test and control groups, the variations in model coefficients may be displayed to the user in the form of percentages, or a graphical representation of how the models of the two groups match. In one embodiment, a user may narrow or expand which model coefficients and/or relative data are utilized when forming the groups. Furthermore, through this interface, a user may setup the experiment they wish to run. For example, a user may determine the effects of allowing the reactive retail pricing system to automatically adjust prices on a daily basis, as opposed to a weekly basis. As another example, the test vs. control interface may be interfaced with an external system, so that it may be used to test different marketing campaigns; the reactive retail pricing system would create the test and control groups and monitor the performance.

FIG. 7 shows a collection of user interfaces for adjusting price campaigns, according to one or more embodiments. As an option, the collection of user interfaces 700 may be implemented in the context of the architecture and environment of the previous Figures or any subsequent Figure(s). Of course, however, the collection of user interfaces 700 may be carried out in any desired environment. It should also be noted that the aforementioned definitions may apply during the present description.

In various embodiments, adjustment user interface 702 allows a user to modify the price campaign for specified products 706 in specified markets 708. Specifically, a user may define a set of strategies, goals, and constraints through a campaign parameter element 704. As shown, some users may not have the ability to change previously selected strategies, goals, and constraints, as they may lack sufficient privileges. Instead, the user may be able to modify aspects of the campaign. As a specific example, as shown in FIG. 7, a retail executive has determined that these products in these markets need to be priced within a certain percentage of Amazon.com. The user, a category manager responsible for these products, is able to slightly modify the threshold percentage (perhaps within a range approved by the executive), but is not able to select a different competitor.

A user with executive privileges may be able to add or delete strategies, goals, and/or constraints. For example, in one embodiment, a user with sufficient privileges may be presented with a list of different types of strategies (e.g. how to behave with respect to a competitor, pricing of one brand with respect to another, etc.), goals (e.g. market share, profitability, price image, branding, etc.), and constraints (e.g. price ceiling, price floor, target inventory, relative pricing of brands, etc.). The user may select one or more strategies, goals, and/or constraints, and provide parameters. In one embodiment, the user may specify the exact parameters to be applied; in another embodiment, the user may specify an approved range of parameters, giving another user with lesser privileges (e.g. a category manager, etc.) the freedom to choose how the strategy, goal, or constraint is implemented.

As shown, adjustment interface 702 displays recommended and current prices 710 for the specified products, as well as projected and past performance 712, as determined by the reactive retail pricing system with the given strategies, goals, and constraints, in accordance with one embodiment. In some embodiments, if the user has specified multiple products and/or markets, the prices 710 and performances 712 displayed in interface 702 may be iconic representations which, when selected, will display a detailed breakdown of all specified products and markets. For example, the user may be provided with a table of products and markets, displaying recommended and current prices; the rows and columns of the table may be grouped in a nested fashion, allowing the user to focus on a particular part of the table. As an option, performance projections may be displayed for cells selected in the table, similar to what is illustrated in user interface 622 of FIG. 6. In another embodiment, a user may be able to modify the price of a product using a slider, and see the projected performance as calculated by the system.

When a user has made adjustments to the strategies, goals, and/or constraints through campaign parameter element 704, a refresh button 714 may become available, in accordance with one embodiment. This button will cause the reactive retail pricing system to recalculate recommended pricing for the specified products and markets, based on the new strategies, goals, and constraints. Once the calculations are complete, the pricing and performance elements (710 and 712, respectively) are updated. Once a user is satisfied with the parameters for the price campaign, they may use button 716 to send the prices to the stores within the specified markets. In some embodiments, button 716 may cause the electronic shelf labels 112 in the specified markets to change at a predetermined time (e.g. instantly, after closing, Tuesday at midnight, etc.).

When a user submits a price change through the “send to stores” button 716, they may be presented with the option of setting up automatic pricing using user interface 718, in accordance with one embodiment. The user may be able to define the limits to the automatic pricing though limit element 720. For example, in one embodiment, a user may be able to specify a minimum and maximum price the reactive retail pricing system is allowed to assign without seeking human authorization. As shown, these limits may be specified in a number of ways, including but not limited to, a price, a percentage of the current price, a percentage of a competitor, and/or within historical limits (e.g. don't set a record high or low, etc.).

A user may also set up one or more alerts using alert element 722, in accordance with one embodiment. For example, a user may specify that they receive email alerts if the automatic pricing reaches a defined limit. A user may also specify the duration of the automatic pricing campaign through duration element 724. Other parameters a user may specify for automatic pricing may include, but are not limited to, the number of allowed price changes, the allowed size of a price change (e.g. whether or not drastic price changes are allowed, etc.), and who has permission to modify the automatic pricing campaign. Once the user is satisfied with the parameters of the automatic pricing campaign, they may initiate the campaign with the “Go Live” button 726. In some embodiments, the user may instead be presented with a “Seek Approval” button, when they lack the authority to enable automatic pricing. In such a case, the request would be presented to a user having sufficient privileges, for there approval.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a reactive retail pricing server, comprising:
obtaining a set of relevant data;
creating a plurality of merchandising sets;
transforming the set of relevant data using a processor and a memory;
calculating coefficients for at least one group model;
performing a reverse transformation on the coefficients;
determining whether at least one of the plurality of merchandising sets and the at least one group model require refinement;
solving for the recommended pricing, wherein retailer strategies, retailer goals, and price campaign parameters are applied as constraints;
automatically calibrating the coefficients for at least one group model; and
processing price campaign adjustments.
